(19) United States
(12) Patent Application Publication
(10) Pub. No.: US 2026/0099958 A1
(43) Pub. Date: Apr. 9, 2026

(54) AUGMENTED REALITY SYSTEM FOR VEHICLE

(71) Applicant: Oshkosh Corporation, Oshkosh, WI (US)

(72) Inventors: Nicholas Weykamp, Oshkosh, WI (US); Joe Wigle, Oshkosh, WI (US); Quincy Wittman, Oshkosh, WI (US); Jacob Wallin, Oshkosh, WI (US); Derek Wente, Oshkosh, WI (US); Vince Andrada, Oshkosh, WI (US); Vince Schad, Oshkosh, WI (US); Jerrod Kappers, Oshkosh, WI (US); Umang Patel, Oshkosh, WI (US)

(73) Assignee: Oshkosh Corporation, Oshkosh, WI (US)

(21) Appl. No.: 19/349,459

(22) Filed: Oct. 3, 2025

Related U.S. Application Data
(60) Provisional application No. 63/703,535, filed on Oct. 4, 2024.

(51) Int. Cl. G06T 11/00; B60R 1/23; B65F 3/02; B65F 3/04; G06V 20/20; G06V 20/56

(52) U.S. Cl. CPC G06T 11/00; B60R 1/23; B65F 3/04; B60R 2300/105; B60R 2300/20; B65F 2003/0269; B65F 2003/0283; G06T 2210/64; G06V 20/20; G06V 20/56

(57) ABSTRACT

A refuse vehicle includes a chassis, a body assembly, an actuator assembly, an output device, and a control system. The actuator assembly is configured to engage with a refuse container. A portion of the actuator assembly is occluded from an operator's view. The output device provides a display. The control system is configured to monitor an operation of the actuator assembly, monitor a location of the refuse container, a portion of the refuse container occluded from the operator's view, generate a graphical representation of at least one of the actuator assembly during operation that includes the portion of the actuator assembly that is occluded or the refuse container that includes the portion of the refuse container that is occluded, and overlay, by the output device, the graphical representation of at least one of the actuator assembly or the refuse container onto the display.

### CROSS-REFERENCE TO RELATED PATENT APPLICATION

This application claims the benefit of and priority to U.S. Provisional Patent Application No. 63/703,535, filed Oct. 4, 2024, the entire contents of which are hereby incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

One embodiment relates to a refuse vehicle including a chassis, a body assembly, an actuator assembly, an output device, and a control system. The chassis is coupled to a plurality of tractive elements. The body assembly is supported by the chassis and defines a refuse compartment configured to receive refuse therein. The actuator assembly is configured to engage with a refuse container and to move the refuse container relative to the body assembly. At least a portion of the actuator assembly is occluded from an operator's view when the operator is positioned in a cab of the refuse vehicle. The output device provides a display. The control system is configured to monitor an operation of the actuator assembly, including the portion of the actuator assembly that is occluded from the operator's view, monitor a location of the refuse container, at least a portion of the refuse container occluded from the operator's view when the operator is positioned in the cab, generate a graphical representation of at least one of (i) the actuator assembly during operation that includes the portion of the actuator assembly that is occluded from the operator's view or (ii) the refuse container that includes the portion of the refuse container that is occluded from the operator's view, and overlay, by the output device, the graphical representation of at least one of the actuator assembly or the refuse container onto the display.

Another embodiment relates to an augmented reality system for a refuse vehicle. The augmented reality system includes one or more processing circuits configured to monitor a location of an object relative to the refuse vehicle, wherein a component of the refuse vehicle occludes at least a portion of the object from an operator's view when the operator is positioned in a cab of the refuse vehicle, generate a graphical representation of the object, including the occluded portion of the object, the graphical representation indicative of the location of the object, and overlay the graphical representation of the object onto the component of the refuse vehicle that occludes the portion of the object.

Still another embodiment relates to an augmented reality system for a refuse vehicle. The augmented reality system includes a display and one or more processing circuits configured to monitor a location of an actuator assembly of the refuse vehicle, wherein a component of the refuse vehicle occludes at least a portion of the actuator assembly from an operator's view when the operator is positioned in a cab of the refuse vehicle, generate a graphical representation of the actuator assembly that includes the portion of the actuator assembly that is occluded from the operator's view, the graphical representation indicative of the location of the actuator assembly, and overlay, on the display, the graphical representation of the actuator assembly onto a live video feed of the component of the refuse vehicle displayed by the display.

### BRIEF DESCRIPTION OF THE DRAWINGS

The disclosure will become more fully understood from the following detailed description, taken in conjunction with the accompanying figures, wherein like reference numerals refer to like elements, in which:

FIGS. 1A and 1B are perspective views of a refuse vehicle, according to some embodiments;

FIG. 2A is a perspective view of a first type of actuator assembly for use with the refuse vehicle of FIGS. 1A and 1B, according to some embodiments;

FIG. 2B is a perspective view of a second type of actuator assembly for use with the refuse vehicle of FIGS. 1A and 1B, according to some embodiments;

FIGS. 3A-3C are example configurations of the refuse vehicle of FIGS. 1A and 1B, according to some embodiments;

FIG. 4 a block diagram of a controller for use with a refuse vehicle, according to some embodiments;

FIG. 5 is a perspective view of a user interface including a joystick for use with a refuse vehicle, according to some embodiments;

FIG. 6 is a perspective view of a user interface including a steering wheel for use with a refuse vehicle, according to some embodiments;

FIG. 7 is a top perspective view of an interior of the cab of the refuse vehicle of FIGS. 1A and 1B including a side mirror displaying an augmented reality (AR) application, according to some embodiments;

FIGS. 8 and 9 side views of the interior of the cab FIG. 7 including an operator wearing a head-mounted display displaying the AR application, according to some embodiments; and

FIGS. 10 and 11 are top perspective views of the interior of the cab FIG. 7 including a front windshield displaying the AR application, according to some embodiments.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Referring generally to the figures, systems and methods for a control system including an augmented reality application are shown, according to various embodiments. The refuse can detection systems may include a controller configured to receive and process data from a plurality of cameras and/or sensors coupled to a refuse vehicle. The refuse vehicle may be a garbage truck, a waste collection truck, a sanitation truck, etc., configured for side-loading, front-loading, or rear-loading. The plurality of cameras and/or sensors (e.g., LIDAR, radar, etc.) and the controller may be disposed in any suitable location on the refuse vehicle. The controller may process data from the cameras and/or sensors to detect the presence of refuse cans, a location of the arms of an actuator assembly, and objects, for example. The location of an identified refuse can or other object may be determined and used to navigate the refuse vehicle and/or the actuator assembly of the refuse vehicle to engage the refuse can.

The control system includes an augmented reality (AR) application configured to enhance the operation of a refuse vehicle by providing real-time visual feedback and operational data to the operator. The AR application is configured to display navigation instructions, such as route guidance and upcoming stops, as well as information on traffic signs along the road. Integrated vehicle warning systems such as alerts for potential hazards or maintenance issues, may be displayed by the AR application. According to an exemplary embodiment, the AR application is configured to display an indication regarding operation of the actuator assembly, including the location and movement of the arms of the actuator assembly, as they engage with refuse cans; a trajectory associated with navigating the vehicle and/or lift system into alignment with the refuse cans; an occluded a portion of the actuator assembly that is occluded by the vehicle or other component during operation; and/or other operational information. The AR application may be displayed on various displays, including a head-mounted display worn by the operator or on a display within a cab of the refuse vehicle (e.g., along a side mirror, door, roof, pillar, etc.).

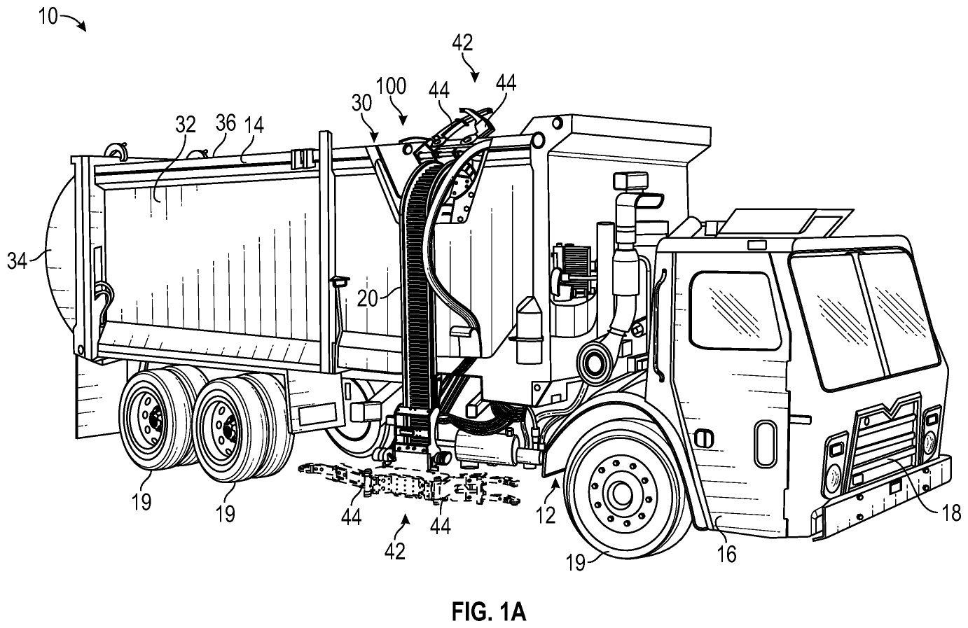

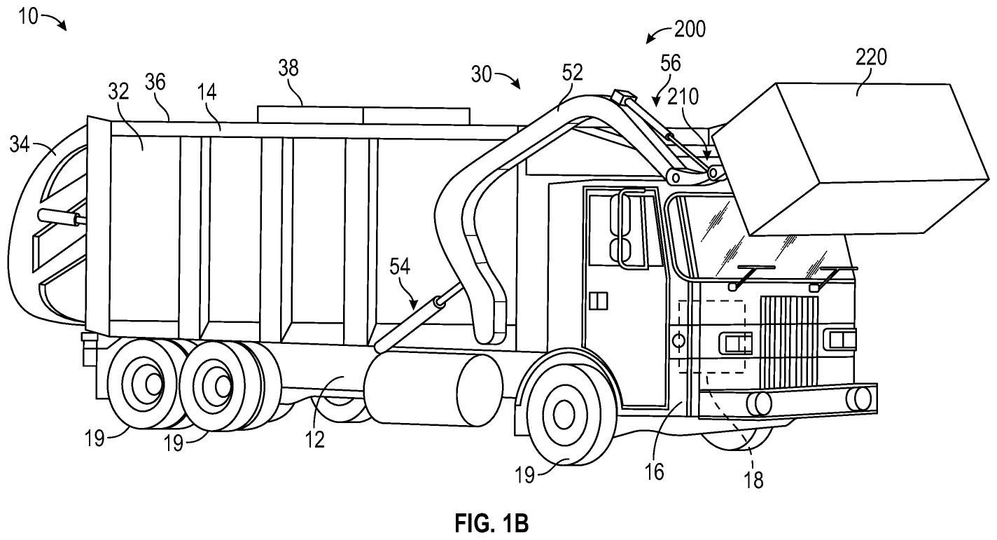

Referring now to FIGS. 1A and 1B, a refuse vehicle 10 is shown, according to some embodiments. The refuse vehicle 10 may be a garbage truck, a waste collection truck, a sanitation truck, etc., and may be configured as a side-loading refuse truck (e.g., as shown in FIG. 1A), front-loading refuse truck (e.g., as shown in FIG. 1B), or a rear-loading refuse truck. In other embodiments, the refuse vehicle 10 is another type of vehicle (e.g., a skid-loader, a telehandler, a plow truck, a boom lift, etc.). As shown, the refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator, such as a seat, a steering wheel, hydraulic controls, a graphical user interface (e.g., a touchscreen user interface), switches, buttons, dials, etc.

As shown, the refuse vehicle 10 includes a prime mover, shown as engine 18, coupled to the frame 12 at a position beneath the cab 16. The engine 18 is configured to provide power to a series of tractive elements, shown as wheels 19, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from an on-board storage device (e.g., batteries, ultracapacitors, etc.), from an on-board generator (e.g., an internal combustion engine, etc.), and/or from an external power source (e.g., overhead power lines, etc.) and provide power to the systems of the refuse vehicle 10.

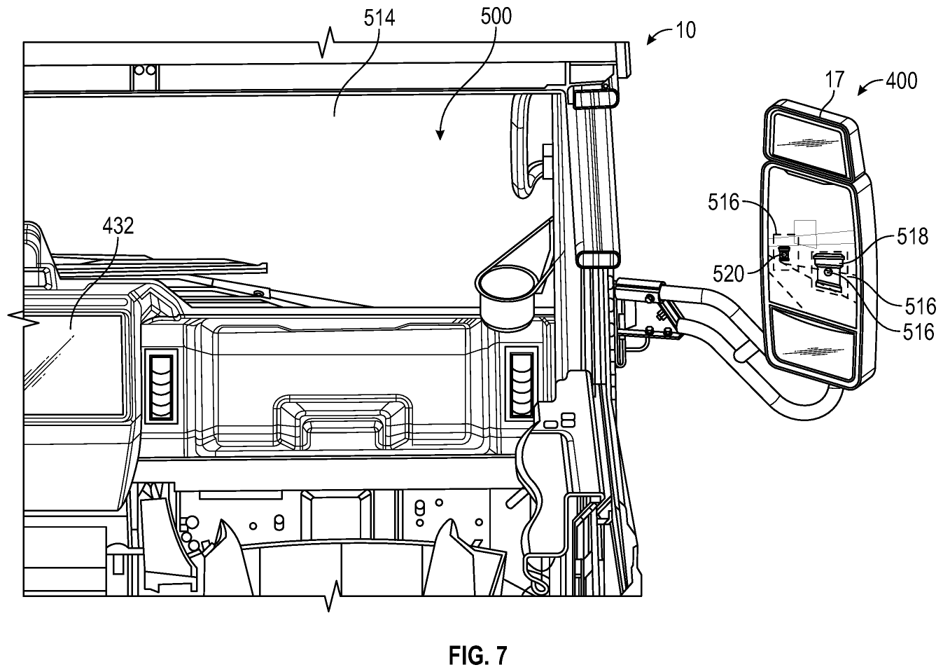

As shown in FIG. 7, the refuse vehicle 10 includes a pair of mirrors 17 positioned on laterally opposing sides of an exterior of the refuse vehicle 10 (e.g., proximate the cab 16) and viewable from an interior of the cab 16. Various settings regarding the mirrors 17 may be adjusted by a controller (e.g., the controller 402) such as a position, an orientation, etc.

In some embodiments, the refuse vehicle 10 is configured to transport refuse from various waste receptacles within a municipality to a storage and/or processing facility (e.g., a landfill, an incineration facility, a recycling facility, etc.). As shown, the body 14 includes a plurality of panels, shown as panels 32, a tailgate 34, and a cover 36. In some embodiments, as shown in FIG. 1B, the body 14 further includes a door, shown as top door 38, which is movably coupled along the cover 36 to seal the opening thereby preventing refuse from escaping the refuse compartment 30 (e.g., due to wind, bumps in the road, etc.). The panels 32, the tailgate 34, the cover 36, and/or the top door 38 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. In some embodiments, the body 14 and the refuse compartment 30 are positioned behind the cab 16.

In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (i.e., refuse is loaded into a position of the refuse compartment 30 behind the cab 16 and stored in a position further toward the rear of the refuse compartment 30). In other embodiments, the storage volume is positioned between the hopper volume and the cab 16 (e.g., a rear-loading refuse vehicle, etc.).

As shown in FIG. 1A, the refuse vehicle 10, when configured as a side-loading refuse vehicle, may include a side-loading lift mechanism/system (i.e., a side-loading lift assembly), shown as lift assembly 100. The lift assembly 100 includes a grabber assembly, shown as grabber assembly 42, slidably coupled to a guide, shown as track 20, and configured to move along an entire length of the track 20. The track 20 is shown to extend along substantially an entire height of the body 14 and is configured to cause the grabber assembly 42 to tilt or rotate near an upper height of the body 14. In other embodiments, the track 20 extends along substantially an entire height of the body 14 on a rear side of the body 14.

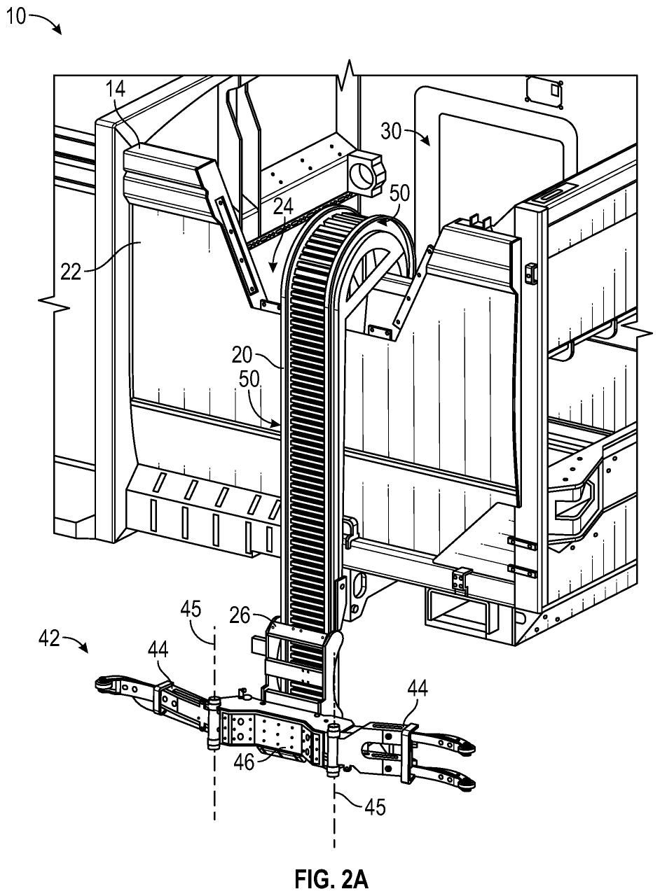

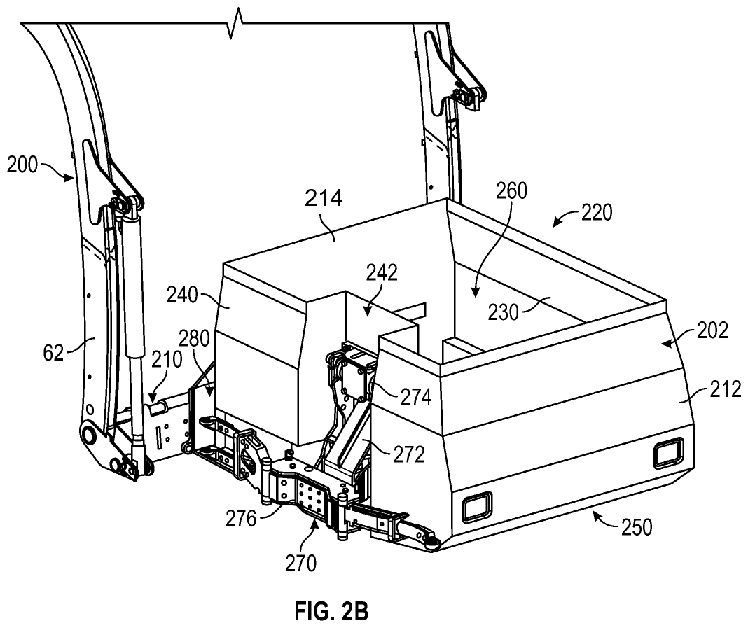

The grabber assembly 42 is shown to include a pair of actuators, shown as actuators 44. The actuators 44 are configured to releasably secure a refuse container to the grabber assembly 42, according to an exemplary embodiment. The actuators 44 are selectively repositionable (e.g., individually, simultaneously, etc.) between an engaged position or state and a disengaged position or state. In the engaged position, the actuators 44 are rotated towards one other such that the refuse container may be grasped therebetween. In the disengaged position, the actuators 44 rotate outwards (e.g., as shown in FIG. 2A) such that the refuse container is not grasped by the actuators 44. By transitioning between the engaged position and the disengaged position, the actuators 44 releasably couple the refuse container to grabber assembly 42.

In operation, the refuse vehicle 10 may pull up alongside the refuse container, such that the refuse container is positioned to be grasped by the grabber assembly 42 therein. The grabber assembly 42 may then transition into an engaged state to grasp the refuse container. After the refuse container has been securely grasped, the grabber assembly 42 may be transported along the track 20 (e.g., by an actuator) with the refuse container. When the grabber assembly 42 reaches the end of the track 20, the grabber assembly 42 may tilt and empty the contents of the refuse container into the refuse compartment 30. The tilting is facilitated by the path of the track 20. When the contents of the refuse container have been emptied into the refuse compartment 30, the grabber assembly 42 may descend along the track 20 and return the refuse container to the ground. Once the refuse container has been placed on the ground, the grabber assembly 42 may transition into the disengaged state, releasing the refuse container.

As shown in FIG. 1B, the refuse vehicle 10, when configured as a front-loading refuse vehicle, may include side-loading lift mechanism/system (i.e., a front-loading lift assembly), shown as lift assembly 200. The lift assembly 200 includes a pair of arms, shown as lift arms 52, coupled to the frame 12 and/or the body 14 on either side of the refuse vehicle 10 such that the lift arms 52 extend forward of the cab 16 (e.g., a front-loading refuse vehicle, etc.). In other embodiments, the lift assembly 200 extends rearward of the body 14 (e.g., a rear-loading refuse vehicle, etc.). In still other embodiments, the lift assembly 200 extends from a side of the body 14 (e.g., a side-loading refuse vehicle, etc.). The lift arms 52 may be rotatably coupled to frame 12 with a pivot (e.g., a lug, a shaft, etc.). As shown, the lift assembly 200 includes first actuators, shown as lift arm actuators 54 (e.g., hydraulic cylinders, etc.), coupled to the frame 12 and the lift arms 52. The lift arm actuators 54 are positioned such that extension and retraction thereof rotates the lift arms 52 about an axis extending through the pivot, according to an exemplary embodiment.

An attachment assembly 210 may be coupled to the lift arms 52 of the lift assembly 200. As shown, the attachment assembly 210 is configured to engage with a first attachment, shown as container attachment 220, to selectively and releasably secure the container attachment 220 to the lift assembly 200. In some embodiments, the attachment assembly 210 is configured to engage with a second attachment, such as a fork attachment, to selectively and releasably secure second attachment to the lift assembly 200. In various embodiments, the attachment assembly 210 is configured to engage with another type of attachment (e.g., a street sweeper attachment, a snow plow attachment, a snowblower attachment, a towing attachment, a wood chipper attachment, a bucket attachment, a cart tipper attachment, a grabber attachment, etc.).

As shown in FIG. 1B, the lift arms 52 are rotated by the lift arm actuators 54 to lift the container attachment 220 or other attachment over the cab 16. The lift assembly 200 includes second actuators, shown as articulation actuators 56 (e.g., hydraulic cylinders, etc.). In some embodiments, the articulation actuators 56 are positioned to articulate the attachment assembly 210. Such articulation may assist in tipping refuse out of the container attachment 220 and/or a refuse container (e.g., coupled to the lift assembly 200 by a fork attachment, etc.) and into the hopper volume of the refuse compartment 30 through an opening in the cover 36. The lift arm actuators 54 may thereafter rotate the lift arms 52 to return the empty container attachment 220 to the ground. In some embodiments, the top door 38 is movably coupled along the cover 36 to seal the opening thereby preventing refuse from escaping the refuse compartment 30 (e.g., due to wind, bumps in the road, etc.).

Referring now to FIGS. 2A and 2B, detailed perspective views of lift assemblies for use with the refuse vehicle 10 are shown, according to some embodiments. Specifically, FIG. 2A shows a detailed, perspective view of the lift assembly 100, according to some embodiments. As described above, the lift assembly 100 includes the track 20 and the grabber assembly 42, which includes a frame, chassis, or connecting member, shown as carriage 26. The track 20 extends along substantially the entire height of the body 14, according to the exemplary embodiment shown. The body 14 includes a panel, shown as loading section 22, that defines a cutout or notch, shown as recess 24, through which the track 20 passes. The recess 24 facilitates a curved portion of the track 20 extending around the top of the loading section 22 without increasing the overall height of the refuse vehicle 10. When the grabber assembly 42 moves along the curved portion of the track 20, the grabber assembly 42 is inverted to empty the refuse container releasably coupled to the grabber assembly 42 into the refuse compartment 30.

The carriage 26 is slidably coupled to the track 20. In operation, the carriage 26 may translate along a portion or all of the length of the track 20. The carriage 26 is removably coupled (e.g., by removable fasteners) to a body or frame of the grabber assembly 42, shown as grabber frame 46. Alternatively, the grabber frame 46 may be fixedly coupled to (e.g., welded to, integrally formed with, etc.) the carriage 26. The actuators 44 are each pivotally coupled to the grabber frame 46 such that they rotate about a pair of axes 45. The axes 45 extend substantially parallel to one another and are longitudinally offset from one another. In some embodiments, one or more actuators configured to rotate the actuators 44 between the engaged state and the disengaged state are coupled to the grabber frame 46 and/or the carriage 26.

Referring now to FIG. 2B, a detailed, perspective view of the lift assembly 200 is shown, according to some embodiments. As shown, the container attachment 220 includes a container, shown as refuse container 202; an articulating refuse collection arm, shown as collection arm assembly 270; and an interface, shown as attachment interface 280. The refuse container 202 has a first wall, shown as front wall 212; an opposing second wall, shown as rear wall 214 (e.g., positioned between the cab 16 and the front wall 212, etc.); a first sidewall, shown as first sidewall 230; an opposing second sidewall, shown as second sidewall 240; and a bottom surface, shown as bottom 250. The front wall 212, the rear wall 214, the first sidewall 230, the second sidewall 240, and the bottom 250 cooperatively define an internal cavity, shown as container refuse compartment 260. According to an exemplary embodiment, the container refuse compartment 260 is configured to receive refuse from a refuse container (e.g., a residential garbage can, a recycling bin, etc.).

As shown, the second sidewall 240 of the refuse container 202 defines a cavity, shown as recess 242. The collection arm assembly 270 is coupled to the refuse container 202 and may be positioned within the recess 242. In other embodiments, the collection arm assembly 270 is otherwise positioned (e.g., coupled to the rear wall 214, coupled to the first sidewall 230, coupled to the front wall 212, etc.). According to an exemplary embodiment, the collection arm assembly 270 includes an arm, shown as arm 272; a grabber assembly, shown as grabber 276, coupled to an end of the arm 272; and an actuator, shown as actuator 274. The actuator 274 may be positioned to selectively reorient the arm 272 such that the grabber 276 is extended laterally outward from and retracted laterally inward toward the refuse container 202 to engage (e.g., pick up, etc.) a refuse container (e.g., a garbage can, a reclining bin, etc.) for emptying refuse into the container refuse compartment 260.

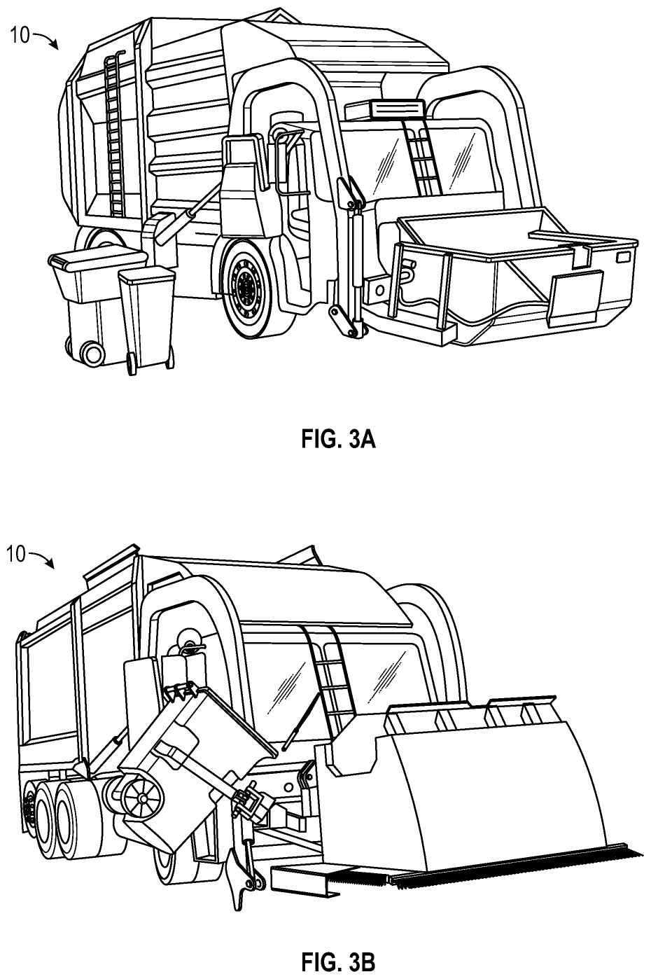

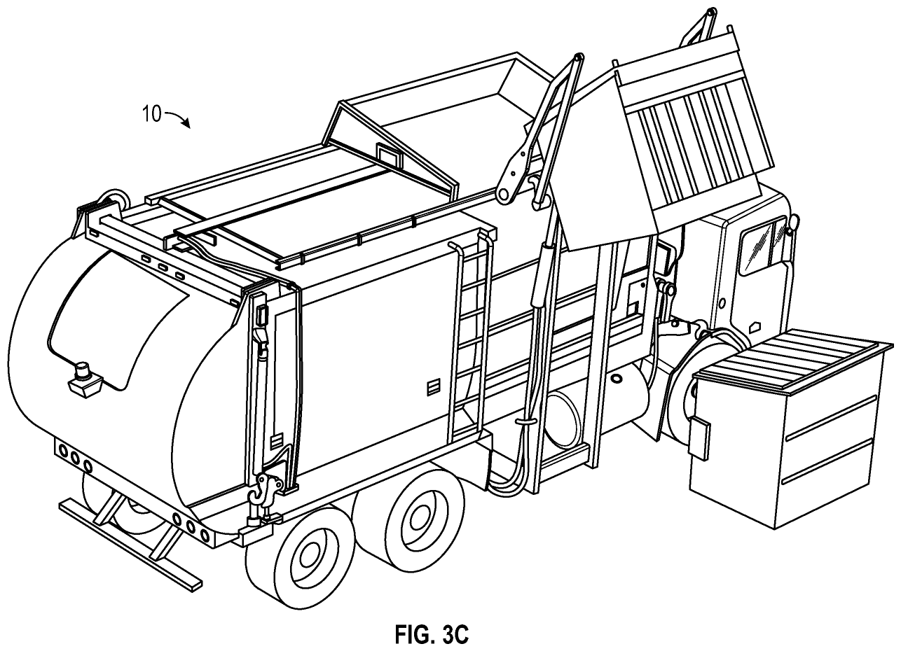

Referring now to FIGS. 3A-3C, example configurations of refuse vehicle 10 are shown, according to some embodiments. FIGS. 3A-3C may illustrate examples of potential configurations of refuse vehicle 10 in addition to the configurations described above with respect to FIGS. 1A-1B and 2A-2B. Specifically, FIG. 3A illustrates a front-loading configuration of refuse vehicle 10 with an intermediate storage container. FIG. 3B illustrates another front-loading configuration of refuse vehicle 10 with an intermediate storage container that includes an actuator assembly (e.g., similar to container attachment 220). FIG. 3C illustrates a side-loading configuration of refuse vehicle 10 (e.g., an auto side-loader) with a grabber-tipper assembly configured to engage an industrial or commercial refuse container. It will be appreciated that the configurations shown in FIGS. 3A-3C illustrate example configurations of refuse vehicle 10 and are not intended to be limiting. As described above, refuse vehicle 10 may be configured in any number of front, side, and/or rear-loading configurations, with any type of lift and/or grabber assembly for engaging a commercial or residential refuse can.

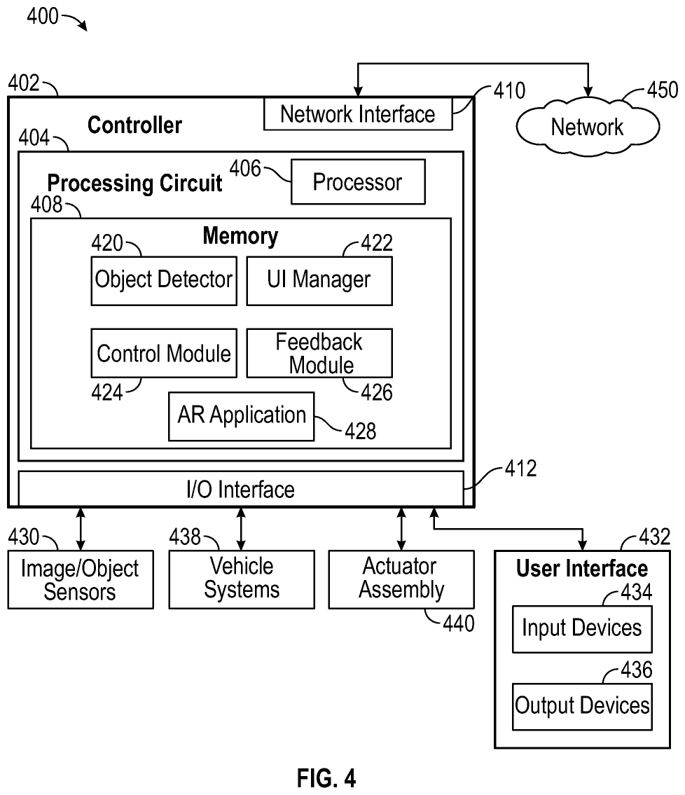

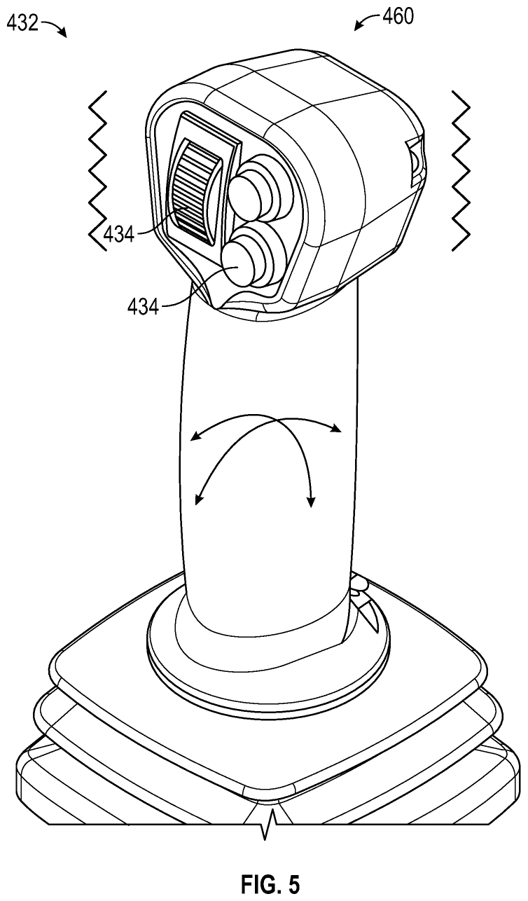

Referring now to FIG. 4, a control system 400 including a controller 402 of the refuse vehicle 10 is shown, according to some embodiments. The controller 402 may be configured to receive data from image and/or object sensors (i.e., cameras and sensors) to detect and/or track a plurality of refuse cans located on any side of a refuse vehicle (e.g., the front, sides, or rear of refuse vehicle 10). The controller 402 may be further configured to initiate automated control actions based on the detection of a refuse can. It will be appreciated that the controller 402 may be implemented via single controller or may be implemented across multiple controllers or devices.

The controller 402 may be one of one or more controllers of the refuse vehicle 10, for example. The controller 402 generally receives and processes data from one or more image and/or object sensors disposed at various locations of the refuse vehicle 10 to identify refuse cans located on at least the curb side of refuse vehicle 10. The controller 402 is shown to include a processing circuit 404 including a processor 406 and a memory 408. In some embodiments, the processing circuit 404 is implemented via one or more graphics processing units (GPUs). The processor 406 can be implemented as a general purpose processor, an application specific integrated circuit (ASIC), one or more field programmable gate arrays (FPGAs), a group of processing components, or other suitable electronic processing components. In some embodiments, the processor 406 is implemented as one or more graphics processing units (GPUs).

The memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 408 can be or include volatile memory or non-volatile memory. The memory 408 can include database components, object code components, script components, or any other type of information structure for supporting the various activities and information structures described in the present application. According to an example embodiment, the memory 408 is communicably connected to the processor 406 via the processing circuit 404 and includes computer code for executing (e.g., by the processing circuit 404 and/or the processor 406) one or more processes described herein.

The processing circuit 404 can be communicably connected to a network interface 410 and an input/output (I/O) interface 412, such that the processing circuit 404 and the various components thereof can send and receive data via the network interface 410 and the I/O interface 412. In some embodiments, the controller 402 is communicably coupled with a network 450 via the network interface 410, for transmitting and/or receiving data from/to network connected devices. The network 450 may be any type of network (e.g., intranet, Internet, VPN, a cellular network, a satellite network, etc.) that allows the controller 402 to communicate with other remote systems. For example, the controller 402 may communicate with a server (i.e., a computer, a cloud server, etc.) to send and receive information regarding operations of the controller 402 and/or the refuse vehicle 10.

The network interface 410 may include any type of wireless interface (e.g., antennas, transmitters, transceivers, etc.) for conducting data communications with the network 450. In some embodiments, the network interface 410 includes a cellular device configured to provide the controller 402 with Internet access by connecting the controller 402 to a cellular tower via a 2G network, a 3G network, an LTE network, etc. In some embodiments, the network interface 410 includes other types of wireless interfaces such as Bluetooth, WiFi, Zigbee, etc.

In some embodiments, the controller 402 is configured to receive over-the-air (OTA) updates or other data from a remote system (e.g., a server, a computer, etc.) via the network 450. The OTA updates may include software and firmware updates for the controller 402, for example. Such OTA updates may improve the robustness and performance on the controller 402. In some embodiments, the OTA updates are received periodically to keep the controller 402 up-to-date.

In some embodiments, the controller 402 is communicably coupled to any number of subsystems and devices of the refuse vehicle 10 via the I/O interface 412. The I/O interface 412 may include wired or wireless interfaces (e.g., antennas, transmitters, transceivers, wire terminals, etc.) for conducting data communications with subsystems and/or devices of the refuse vehicle 10. In some embodiments, the I/O interface 412 includes a Controller Area Network (CAN) bus, a Local Interconnect Network (LIN) bus, a Media Oriented Systems Transport (MOST) bus, an SAE Jl850 bus, an Inter-Integrated Circuit (12C) bus, etc., or any other bus commonly used in the automotive industry. As shown, the I/O interface 412 may transmit and/or receive data from a plurality of vehicle subsystems and devices including image/object sensors 430, a user interface 432, vehicle systems 438, and/or an actuator assembly 440.

As described herein, the image/object sensors 430 may include any type of device that is configured to capture data associated with the detection of objects such as refuse cans. In this regard, the image/object sensors 430 may include any type of image and/or object sensors, such as one or more visible light cameras, full-spectrum cameras, LIDAR cameras/sensors, radar sensors, infrared cameras, image sensors (e.g., charged-coupled device (CCD), complementary metal oxide semiconductor (CMOS) sensors, etc.), or any other type of suitable object sensor or imaging device. Data captured by the image/object sensors 430 may include, for example, raw image data from one or more cameras (e.g., visible light cameras) and/or data from one or more sensors (e.g., LIDAR, radar, etc.) that may be used to detect objects.

Generally, the image/object sensors 430 may be disposed at any number of locations throughout and/or around the refuse vehicle 10 for capturing image and/or object data from any direction with respect to the refuse vehicle 10. For example, the image/object sensors 430 may include a plurality of visible light cameras and LIDAR cameras/sensors mounted on the forward and lateral sides of the refuse vehicle 10 for capturing data as the refuse vehicle 10 moves down a path (e.g., a roadway). In some embodiments, one or more of the image/object sensors 430 are located on an attachment utilized by the refuse vehicle 10, such as the container attachment 220 described above.

The user interface 432 may be any electronic device that allows a user to interact with the controller 402. The user interface 432 is configured to provide an operator with the ability to control one or more functions of and/or provide commands to the refuse vehicle 10 and the components thereof such as the vehicle systems 438 (e.g., turn on, turn off, drive, turn, brake, engage various operating modes, raise/lower an implement, etc.). Examples of user interfaces or devices include, but are not limited to, mobile phones, electronic tablets, laptops, desktop computers, augmented reality headsets, virtual reality headsets, workstations, and other types of electronic devices. As shown in FIG. 4, the user interface 432 includes one or more first devices, shown as input devices 434, configured to receive an input from an operator of the refuse vehicle 10 to control one or more functions of and/or provide commands to the refuse vehicle 10 and the components thereof. The input devices 434 may be or include a steering interface (e.g., a steering wheel, joystick(s), etc.), an accelerator interface (e.g., a pedal, a throttle, etc.), a braking interface (e.g., a pedal), and one or more other buttons, switches, knobs, levers, dials, etc. As shown in FIG. 4, the user interface 432 includes one or more second devices, shown as output devices 436, configured to provide an audible indication (e.g., alert, sound, message, tone, etc.), a visual indication (e.g., alert, message, warning, image, video, etc.), and/or a haptic indication (e.g., vibration, pulse, etc.), among other indications for providing information to the operator relating to the operation of (e.g., status, location, etc.) the refuse vehicle 10 and the components thereof. The output devices 436 may be or include a touchscreen, a LCD display, a LED display, a head-mounted display, a heads-up display, a speedometer, gauges, warning lights, speakers, sirens, horns, haptic actuators, etc. By way of example, the user interface 432 may include a touchscreen located in the cab 16 of the refuse vehicle 10 and configured to present an operator with a variety of information regarding the operations of the refuse vehicle 10. By way of another example, the user interface 432 may include an augmented reality headset that the operator wears and is configured to display an augmented reality application. By way of another example, the user interface 432 is a display included in or projected onto a windshield, an interior surface of the cab 16 (e.g., an interior surface of a door of the cab 16, a roof of the cab 16, an A-pillar, a B-pillar, a ground floor of the cab 16, etc.), the side mirror, etc.

The vehicle systems 438 may include any subsystem or device associated with the refuse vehicle 10. The vehicle systems 438 may include, for example, powertrain components (e.g., the engine 18), steering components, a grabber arm, lift assemblies, etc. The vehicle system 438 may also include electronic control modules, control units, and/or sensors associated with any systems, subsystems, and/or devices of the refuse vehicle 10. For example, the vehicle system 438 may include an engine control unit (ECU), a transmission control unit (TCU), a Powertrain Control Module (PCM), a Brake Control Module (BCM), a Central Control Module (CCM), a Central Timing Module (CTM), a General Electronic Module (GEM), a Body Control Module (BCM), an actuator or grabber assembly control module, etc. In this manner, any number of vehicle systems and devices may communicate with the controller 402 via the I/O interface 412.

The actuator assembly 440 may include at least the components of a lift assembly for engaging, lifting, and emptying a refuse can. The actuator assembly 440 can include, for example, any of the components of the lift assembly 100 and/or the lift assembly 200, described above with respect to FIGS. 1A and 1B. In general, the actuator assembly 440 may include at least a grabber assembly (e.g., grabber assembly 42) configured to move to engage a refuse can. The actuator assembly 440 may include a plurality of actuators (e.g., linear actuators, lift actuators, horizontal actuators, etc.) for moving to engage the refuse can. As an example, the actuator assembly 440 may be configured to move horizontally, vertically, orthogonally, etc., relative to the refuse vehicle 10 in order to engage a refuse can. In some embodiments, the actuator assembly 440 further includes an actuator assembly control module, configured to receive data and/or signals from the controller 402 to initiate control actions for a grabber arm or actuator.

Still referring to FIG. 4, the memory 408 is shown to include an object detector 420. The object detector 420 may generally receive and process data from the image/object sensors 430 to detect objects (e.g., refuse cans). It will be appreciated that, has denoted herein, the data received and process by the object detector 420 may include any type of data as described above with respect to the image/object sensors 430, including video from which images and/or other image data can be extracted. As described above, the data may also include data from one or more sensors (e.g., LIDAR, radar, etc.) that may be utilized to detect an object (e.g., a refuse can) and/or a location or position of the object. As shown, for example, the object detector 420 may receive data from the image/object sensors 430 via the I/O interface 412.

The object detector 420 may process the received data to detect target objects, including human beings and/or refuse cans. It will be appreciated, however, that the object detector 420 may be configured to detect other objects based on other implementations of the controller 402. In this regard, the object detector 420 may provide means for the controller 402 to detect and track a plurality of refuse cans on a path being traveled by the refuse vehicle 10.

The object detector 420 may include a neural network or other similar model for processing received data (e.g., from the image/object sensors 430) to detect target objects. As described herein, the object detector 420 is generally a one-stage object detector (e.g., deep learning neural network), or may utilize a one-stage object detection method. Unlike two-stage object detectors (e.g., regional convolution neural network (R-CNN), Fast R-CNN, etc.), the object detector 420 may process image data in a single stage and may provide advantages over many two-stage detectors such as increased speed (i.e., decreased computing time). In some embodiments, the object detector 420 is an object detector as described in U.S. application Ser. No. 17/189,740, filed Mar. 2, 2021, the entire disclosure of which is incorporated by reference herein.

Referring again to FIG. 4, the memory 408 is shown to further include a user interface (UI manager) 422. The UI manager 422 may generate a user interface based on data captured by the image/object sensors 430 and/or detected object data from the object detector 420. The UI manager 422 may present a generated user interface via the user interface 432, for example. The user interface may include data captured by the image/object sensors 430 (e.g., live, delayed, or previously captured image data) and an indication of any detected objects within the data. As an example, the user interface may present an image of a path (e.g., roadway) that the refuse vehicle 10 is traveling on, and may indicate one or more detected refuse cans located along the roadway.

The user interface generated by the UI manager 422 may provide means for a user (e.g., an operator of the refuse vehicle 10) to interact with the refuse vehicle 10 and/or the actuator assembly 440 for semi-autonomous or non-autonomous operations. For example, a user interface that indicates two or more refuse cans may provide means for the user to select a particular one of the refuse cans to act on (e.g., to move to and engage). The user interface may also provide other information regarding the operations of the refuse vehicle 10, such as alarms, warnings, and or notifications. In some embodiments, the user interface generated by the UI manager 422 may include a notification when a human being is detected within a danger zone. This may alert an operator to an unsafe condition and/or may indicate to the operator why automated refuse can collection cannot be implemented (e.g., until no human beings are located in a danger zone).

The memory 408 is shown to further include a control module 424. The control module 424 may determine and/or implement control actions based on detected objects (e.g., from the object detector 420) and/or user inputs (e.g., from the user interface 432). In some embodiments, the control module 424 implements any number of automated control actions based on detected objects such as refuse cans and/or human beings. In a first example, the control module 424 may implement automated collection of a refuse can, based on detection of the refuse can. In this example, once a refuse can is detected, a location of the refuse can may be determined using any number of known methods. Based on the determined location of the target refuse can, the control module 424 may determine a trajectory for the refuse vehicle 10 and/or the actuator assembly 440 in order to engage the refuse can.

In some embodiments, the control module 424 controls (e.g., by transmitting control signals) the vehicle systems 438 and/or the actuator assembly 440 to move to and engage the refuse can. For example, the control module 424 may transmit control signals to any number controllers associated with the vehicle systems 438 (e.g., the ECU, the TCU, an automated steering system, etc.) in order to move the refuse vehicle 10 to a desired position near a refuse can. In another example, the control module 424 may transmit control signals to a controller associated with the actuator assembly 440 in order to move/control the actuator assembly 440.

In some embodiments, when a human being is detected within a danger zone (e.g., within a predefined zone and/or distance of the refuse vehicle 10 and/or the actuator assembly 440), the control module 424 initiates safety actions. The safety actions may include, for example, preventing the refuse vehicle 10 and/or the actuator assembly 440 from moving to and/or engaging the refuse can while the human being is detected within the danger zone. In some embodiments, the control module 424 initiates an alert/alarm/notification based on the detection of a human being in a danger zone, and provides an indication of the alert to the UI manager 422 for display via the user interface 432.

Still referring to FIG. 4, the memory 408 is shown to further include a feedback module 426. The feedback module 426 may receive data from the image/object sensors 430 and/or one or more sensors associated with the vehicle systems 438 and/or the actuator assembly 440 to adjust and/or alter a trajectory (i.e., movement) of the refuse vehicle 10 or the actuator assembly 440. In some embodiments, the feedback module 426 processes data (e.g., from the image/object sensors 430 and/or the object detector 420) to adjust and/or alter a trajectory (i.e., movement) of the refuse vehicle 10 or the actuator assembly 440. In some embodiments, the feedback module 426 includes a model for processing feedback data. In some such embodiments, the model may be a recurrent neural network (RNN) or other suitable type of neural network for processing feedback data.

As shown in FIG. 4, the memory 408 includes an application, shown as AR application 428. The AR application 428 may place digital objects (e.g., graphical representations) into a live video feed of the real world and display the combined video feed on the output devices 436 (e.g., a tablet computer, smartphone, laptop, smart TV, head-mounted display, etc.). In some embodiments, the AR application 428 overlays (e.g., superimposes, aligns, etc.) a digital twin (e.g., a graphical representation) of a piece of equipment (e.g., the vehicle systems 438, the actuator assembly 440, objects detected by the object detector 420, etc.) or an environment surrounding the refuse vehicle 10 onto a live video feed of the equipment or the environment. In some embodiments, the AR application 428 is configured to provide an indication (e.g., via the output devices 436) to the operator of the refuse vehicle 10 regarding an operation of the refuse vehicle 10 and the components thereof (e.g., the vehicle systems 438, the actuator assembly 440, etc.). By way of example, the indication may be regarding a driving operation of the refuse vehicle 10 (e.g., a message relating to braking, a message relating to speed, navigation instructions, warning messages, etc.). By way of another example, the indication may be regarding an operation of the vehicle systems 438 and the actuator assembly 440 such as an indication of a location of the arms of the actuator assembly 440 (e.g., an alignment of the arms relative to a refuse can), an indication of a status (e.g., normal operation, restricted operation, disabled operation, etc.) of the vehicle systems 438 and the actuator assembly 440, among other indications.

The controller 402 may be configured to host and process the AR application 428 locally. By way of example, the controller 402 may be a controller on-board the refuse vehicle 10 configured to host and process the AR application 428. By way of another example, the AR application 428 may be hosted and processed by a controller included in the user interface 432 (e.g., by a processing unit of the head-mounted display 510). In some embodiments, the AR application 428 is hosted and processed remote from the refuse vehicle 10 and the user interface 432 by a remote server.

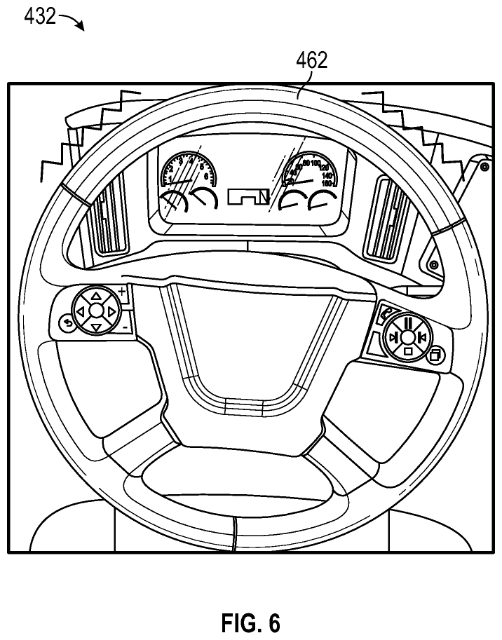

As shown in FIG. 5, the user interface 432 includes a joystick 460 including one or more buttons, knobs, switches, dials, etc. The joystick 460 is configured to receive an input from an operator of the refuse vehicle 10 to control one or more functions of and/or provide commands to the refuse vehicle 10 and the components thereof. In some embodiments, the joystick 460 is movable and configured to control operation of the grabber assembly 42, the lift assembly 100, and/or the lift assembly 200. By way of example, responsive to receiving an input from the operator moving the joystick 460 in a first direction (e.g., backwards), the grabber assembly 42, the collection arm assembly 270, the lift assembly 100, and/or the lift assembly 200 may operate (e.g., move in a direction corresponding to the first direction) to engage, disengage, lift, lower, etc. a refuse can.

As shown in FIG. 6, the user interface 432 includes a steering wheel 462 including one or more buttons, knobs, switches, dials, etc. The steering wheel 462 is configured to receive an input from an operator of the refuse vehicle 10 to control one or more functions of and/or provide commands to the refuse vehicle 10 and the components thereof. By way of example, using the steering wheel 462, the operator may steer the wheels 19 to facilitate turning the refuse vehicle 10.

The joystick 460 and/or the steering wheel 462 may include a haptic actuator configured to provide one or more haptic indications regarding the operation of the refuse vehicle 10 and the components thereof. In some embodiments, the haptic actuator is configured to vibrate, shake, resist input movement, or otherwise actuate to provide the haptic indications to the operator engaged with (e.g., in contact with, holding, grasping, etc.) the joystick 460 and/or the steering wheel 462. In some embodiments, the one or more seats disposed within the cab include the haptic actuator such that the haptic indication is provided to the operator sitting in the seat. Responsive to receiving the haptic indication, the operator may control operation of the refuse vehicle 10 and the components thereof to take corrective measures (e.g., stop operation of the grabber assembly 42 or the collection arm assembly 270 responsive to an indication of an improper alignment, steer the refuse vehicle 10 responsive to an indication of an impending collision, etc.).

By way of example, responsive to a determination by the controller 402 (e.g., based on data acquired by the image/object sensors 430) that the refuse can is not aligned with the actuator assembly 440, the haptic actuator may actuate to provide an indication (e.g., to the operator manually controlling operation of the actuator assembly 440 using the joystick 460, to the operator overseeing autonomous operation of the actuator assembly 440, etc.) that the refuse can is not aligned with the actuator assembly 440. By way of another example, responsive to a determination by the controller 402 (e.g., based on data acquired by the image/object sensors 430) of an impending collision (e.g., an unintended collision) between (i) the actuator assembly 440 or (ii) the refuse vehicle 10 and (iii) an object (e.g., a pedestrian, a ground surface, a refuse can, a tree, a vehicle, etc., or some other hazard detected by the object detector 420), the haptic actuator may actuate to provide an indication (e.g., to the operator manually controlling operation of the actuator assembly 440 using the joystick 460, to the operator steering the refuse vehicle 10 using the steering wheel 462, to the operator overseeing autonomous operation of the refuse vehicle 10, and/or the actuator assembly 440, etc.) indicative of the impending collision. By way of yet another example, the haptic actuator may be configured to provide variable force (e.g., a force that opposes the input provided to the joystick 460 and/or the steering wheel 462 by the operator) to provide an indication of a performance of refuse vehicle 10 and the components thereof (e.g., the indication being indicative of the actuator assembly 440 lifting a heavy refuse can). By way of still another example, responsive to a determination by the controller 402 (e.g., based on data acquired by the image/object sensors 430) that the refuse vehicle 10 is unintentionally drifting out of the lane in which it is traveling and/or that there is a vehicle adjacent to the refuse vehicle 10 in a blind spot of the refuse vehicle 10, the haptic actuator may be configured to actuate (e.g., shake, vibrate, etc.) the steering wheel 462 to provide an indication to the operator of such.

As shown in FIGS. 7-11, an interior volume, shown as cab interior 500, defined by the cab 16 is sized to contain one or more operators. The cab interior 500 contains one or more user interfaces 432 that facilitate operation of the refuse vehicle 10 by the operator. By way of example, the cab interior 500 may contain components that facilitate operator comfort (e.g., seats, seatbelts, etc.), input devices 434 that receive inputs from the operators (e.g., the joystick 460, the steering wheel 462, pedals, touch screens, switches, buttons, levers, etc.), and/or output devices 436 that provide information to the operators (e.g., displays, lights, gauges, speakers, etc.). The user interfaces 432 within the cab 16 may facilitate operator control over the drive components of the refuse vehicle 10 and/or over any implements of the refuse vehicle 10.

According to an exemplary embodiment shown in FIG. 7, the mirrors 17 are configured as an output device 436 including a display configured to display the AR application 428. In such an embodiment, the control system 400 may be integrated into the mirrors 17 of the refuse vehicle 10 such that the mirrors 17 (e.g., the control system 400 integrated into the mirrors 17) are configured to detect objects (e.g., refuse cans, pedestrians, operators, pickup/drop-off locations, hazards, etc.) and provide an indication (e.g., display an indication) of the detected objects (e.g., a type of the object, a position/orientation of the object, etc.). By way of example, the mirrors 17 may include the image/object sensors 430 configured to acquire data indicative of the environment surrounding the refuse vehicle 10, the controller 402 configured to process the data, and an output device 436 configured to display one or more indications (e.g., live video, graphical representations, the AR application 428, messages, etc.) of the data.

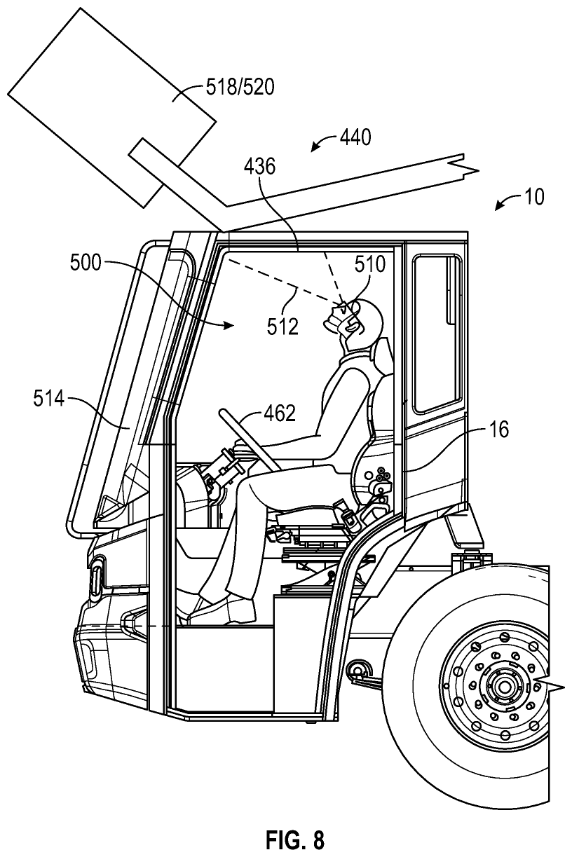

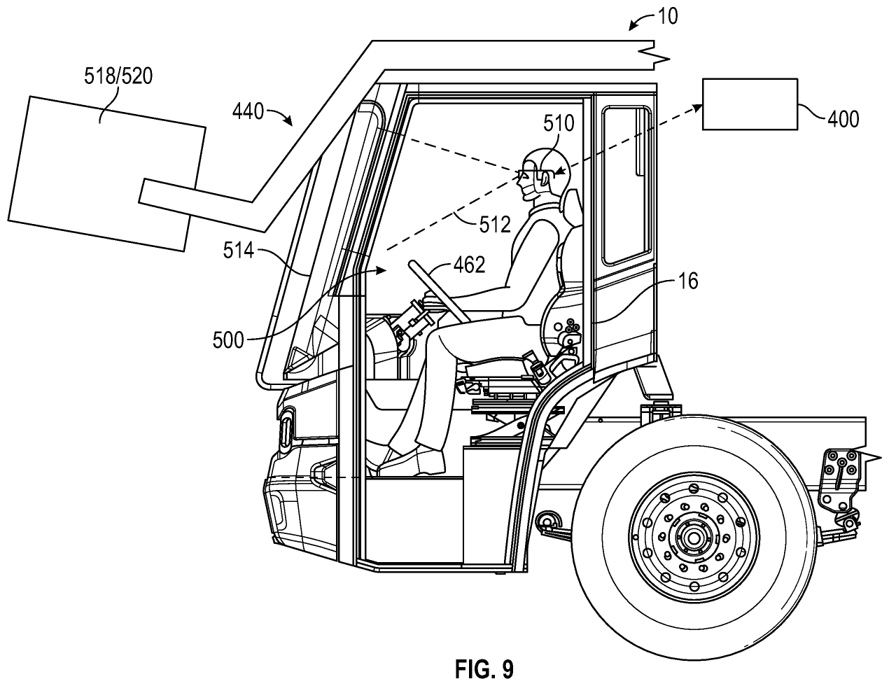

According to an exemplary embodiment shown in FIGS. 8 and 9, an AR headset (e.g., smart glasses, wearable device, etc.), shown as head-mounted display 510, is configured to be worn by an operator of the refuse vehicle 10. The head-mounted display 510 may be an output device 436 configured to display the AR application 428 to the operator wearing the head-mounted display 510. By way of example, head-mounted display 510 may include transparent lenses that allows the operator to see the surrounding environment overlaid with graphical representations of objects, digital warnings, or other information. By way of another example, the head-mounted display 510 may include a display configured to display live video data captured from a point of view of the operator and overlay the live video data with the graphical representations of objects, digital warnings, or other information. As the operator moves their body or their head, a field of view (FOV) 512 of the operator changes and the AR application 428 displayed thereby adjusts a position and orientation of the graphical representations of the objects as viewed by the operator to maintain the position and orientation of the graphical representations of the objects relative to the real world.

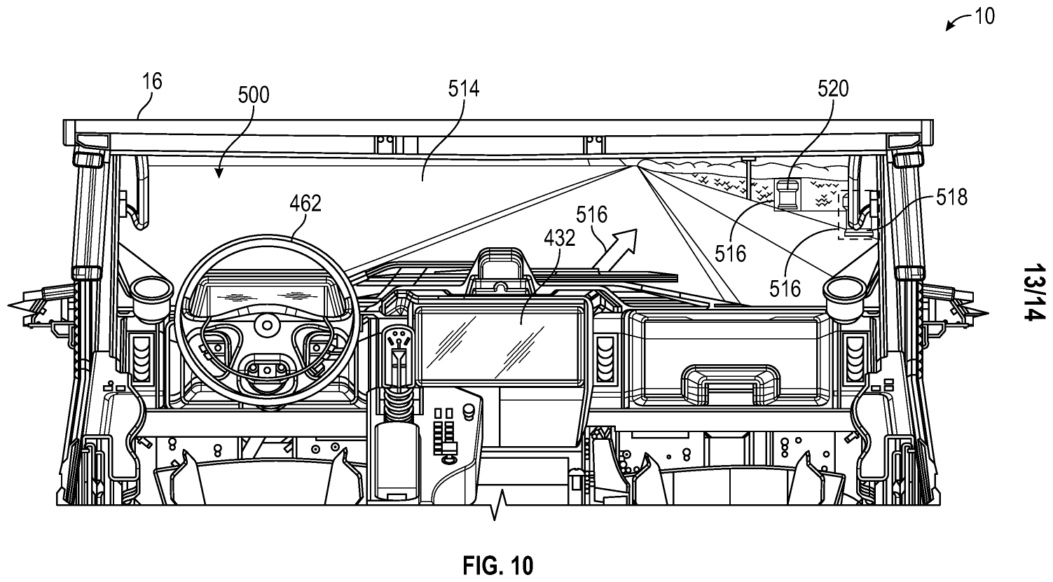

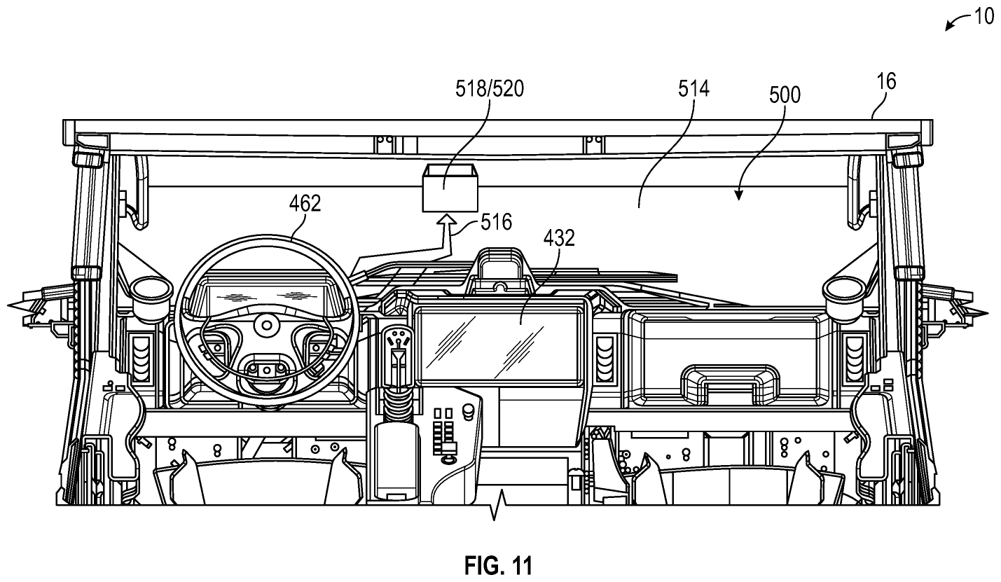

According to an exemplary embodiment shown in FIGS. 10 and 11, the AR application 428 is configured to be displayed on a windshield 514 of the refuse vehicle 10. In some embodiments, the AR application 428 is configured to be projected onto the windshield 514 by a projector. In some embodiments, the AR application 428 displayed by the head-mounted display 510 displays graphical representations of objects, digital warnings (e.g., navigation instruction), or other information as if they are being projected on the windshield 514 or displayed on the objects in the real world. In some embodiments, the windshield 514 includes one or more displays (e.g., LCD displays, LED displays, etc.) configured to display the AR application 428.

The AR application 428 may receive data from the image/object sensors 430 and/or one or more sensors associated with the vehicle systems 438 and/or the actuator assembly 440, generate a graphical representation based on the data, and display the graphical representation on the output devices 436 (e.g., on the mirrors 17, via the head-mounted display 510, on the windshield 514, etc., as discussed in greater detail above) such that the graphical representation appears overlaid onto the real-world equipment or environment (or a live video feed thereof) corresponding with the graphical representation thereof.

The AR application 428 may automatically detect the identity of the equipment and load the graphical representation by recognizing the shape of the equipment or a identification (e.g., color, decal, sticker, QR code, barcode, etc.) affixed to the equipment. By way of example, the AR application 428 may automatically detect and differentiate between a first refuse can for garbage and a second refuse can for recycling based on the color thereof and display graphical representations indicative of the refuse cans being different. As shown in FIG. 7, the AR application 428 may provide an indication 516 that a first refuse can 518 is of a first type (e.g., a recycling refuse can) and that a second refuse can 520 is of a second type (e.g., a garbage refuse can) different than the first type. By way of example, the indication 516 may include an overlay of a graphical representation of the first refuse can 518 and the second refuse can 520, an overlay of a massage (e.g., a message above the refuse cans), an overlay of a box surrounding the refuse can, among other indications indicative of the first refuse can 518 and the second refuse can 520 being of different types. In such an example, as the refuse vehicle 10 moves or as the FOV 512 of the operator changes, the indication 516 may remain overlayed the refuse cans (e.g., fixed relative to the first refuse can 518 and the second refuse can 520). In some embodiments, the AR application 428 is configured to detect whether a refuse can has been overfilled with refuse (e.g., filled beyond a capacity of the refuse can) and transmit a signal to a management system indicative of the overfilled can (the management system may then send a notification to the residence indicating that their refuse can is overfilled).

As shown in FIGS. 10 and 11, in some embodiments, the indication 516 provided to the operator (e.g., displayed by the AR application 428) includes navigations instructions indicative of a collection route the refuse vehicle 10 drives along to collect refuse from refuse cans. By way of example, the indication 516 may include a line or an arrow projected onto the road along which the refuse vehicle 10 should follow. By way of another example, the AR application 428 may display the indication 516 including a top-down view of a map displaying an overview of the collection route. By way of yet another example, the AR application 428 may display the indication 516 including a warning of upcoming traffic signs (e.g., stoplights, stop signs, merge signs, yield signs, etc.) along the collection route. In some embodiments, the indication 516 indicates (e.g., displays a message, symbol, etc.) which refuse cans should be skipped if the homeowner has not paid their bills and which refuse cans should be collected.

In some embodiments, the AR application 428 is configured to display an indication (e.g., the indication 516) indicative of an alignment of the actuator assembly 440 with a refuse can. By way of example, the AR application 428 may display arrows (e.g., left, right, up, or down arrows) instructing which direction to move the arms of the actuator assembly 440 to engage with the refuse can. Once the actuator assembly 440 is engaged with the refuse can (e.g., after capturing the refuse can), the AR application 428 may display an indication (e.g., a message, a symbol, etc.) notifying the operator that the refuse can is engaged.

In some embodiments, the indication 516 displayed by the AR application 428 provides an indication of warnings regarding an operation of the refuse vehicle 10. By way of example, the AR application 428 may display when an automatic braking system has been engaged, when a vehicle is detected in a blind spot of the refuse vehicle 10, when the refuse vehicle 10 is drifting outside of the lane in which it is traveling, a speed of the refuse vehicle 10 relative to a speed limit, etc. In some embodiments, the indication 516 displayed by the AR application 428 provides an indication of warnings regarding an operation of the actuator assembly 440. By way of example, responsive to a determination by the controller 402 (e.g., based on data acquired by the image/object sensors 430) of an impending collision (e.g., an unintended collision) between (i) the actuator assembly 440 and (iii) an object (e.g., a pedestrian, a ground surface, a refuse can, a tree, a vehicle, etc., or some other hazard detected by the object detector 420), the AR application 428 may display a warning indicative of the impending collision. In some embodiments, the indication 516 displayed by the AR application 428 provides an indication of a status of the refuse vehicle 10 such as a position (e.g., open, partially open, closed, etc.) of the tailgate 34, a location of the components of the actuator assembly 440, a status of a packing operation, a weight of the refuse can being supported by the actuator assembly 440, etc. By way of example, when the actuator assembly 440 is above the cab 16, the AR application 428 may provide an indication by pulsing, highlighting, glowing, etc. the roof of the cab 16. In some embodiments, the indication 516 displayed by the AR application 428 provides an indication of when the operator should use regenerative braking to slow or stop the refuse vehicle 10 instead of using friction braking. By way of example, responsive to a determination by the controller 402 (e.g., based on data acquired by the image/object sensors 430) that regenerative braking is a preferred braking method (e.g., based on the topography of the road along the collection route), the AR application 428 may display a message, a symbol, etc. instructing the operator to use regenerative braking.

The AR application 428 may be configured to generate the graphical representation such that one or more components of the graphical representation are at least partially transparent. In some embodiments, the AR application 428 is configured to generate the graphical representation such that one or more components or features of the live video feed of the real-world equipment or environment appear to be transparent. This may improve visibility of certain components that may be blocked by other components (e.g., components that may be occluded from a view of the operator by other components). By way of example, the AR application 428 may generate a graphical representation of the mechanical components of the vehicle systems 438 and/or the actuator assembly 440 (e.g., linkages, arms, walls, platforms, panels, etc.) that are partially transparent such that the components that are hidden or occluded in the real world (e.g., hydraulic and electrical components) can be seen through the mechanical components. By way of another example, the AR application 428 may generate a graphical representation of one or more components or features of the live video feed of the real-world equipment (e.g., a roof of the cab 16, a pillar of the cab 16, etc.) or environment that are partially transparent such that the components that are hidden or occluded in the real world can be seen through the one or more components of the real world.

As shown in FIGS. 8 and 9, during refuse collection operations, the actuator assembly 440 is configured to engage with a refuse can 520 and actuate to move the refuse can 520 and empty the refuse within the refuse can 520 into a refuse compartment (e.g., the refuse compartment 30, the refuse compartment 260). During the refuse collection operations, a portion of the actuator assembly 440, the components thereof, or the refuse can 520 may be hidden (e.g., occluded, out of sight, etc.) from the operator controlling operation of the actuator assembly 440 or monitoring the autonomous operation of the actuator assembly 440. In embodiments where the refuse vehicle 10 is a front-loading refuse truck (e.g., as shown in FIGS. 1B, 8, and 9), the actuator assembly 440 may lift the refuse can 520 over (e.g., above) the cab 16. In such embodiments, a portion of the actuator assembly 440, the components thereof, or the refuse can 520 may be blocked by the cab 16 (e.g., a roof of the cab 16, a front end of the refuse vehicle 10, etc.) or another portion of the refuse vehicle 10 from a view of the operator (e.g., sitting inside the cab 16 or standing outside the cab 16). Similarly, in embodiments where the refuse vehicle 10 is a side-loading refuse vehicle or a rear-loading refuse vehicle, during refuse collection operations, a portion of the actuator assembly 440, the components thereof, or the refuse can 520 may be blocked by the cab 16 or another portion of the refuse vehicle 10 from a view of the operator.

Such limited visibility of the operator may result in the actuator assembly 440, the components thereof, or the refuse can 520 unintentionally contacting an object and causing damage to the refuse vehicle 10. The AR application 428 is configured to generate a graphical representation of the actuator assembly 440, the components thereof, or the refuse can 520 that would otherwise be blocked or occluded by the cab 16 or another portion of the refuse vehicle 10 from a view of the operator. Accordingly, even if a portion of the actuator assembly 440, the components thereof, or the refuse can 520 is blocked from a view of the operator, the AR application 428 facilitates displaying the hidden portions (e.g., the portions that would be hidden without the use of the AR application 428, the occluded portions, etc.) of the actuator assembly 440, the components thereof, or the refuse can 520 to the operator. By way of example, as shown in FIG. 8, when the actuator assembly 440 and the refuse can 520 is above the cab 16, the roof of the cab 16 blocks the operator's view thereof. In such an example, the AR application 428 is configured to make the portion of the roof blocking the actuator assembly 440 and the refuse can 520 transparent and generate a graphical representation that provides an indication of the position and orientation of the actuator assembly 440 and the refuse can 520 such that the operator can control or monitor operation thereof based on the graphical representation. By way of another example, if a component such as a pillar (e.g., A-pillar, B-pillar, etc.), tailgate, compartment, panel, etc. of the refuse vehicle 10 is inhibiting the operator's visibility of the actuator assembly 440 and the refuse can 520, the AR application 428 makes the component of the refuse vehicle 10 transparent and generates a graphical representation that provides an indication of the position and orientation of the actuator assembly 440 and the refuse can 520.

In some embodiments, the AR application 428 is configured to make a component of the refuse vehicle 10 that is blocking a detected object (e.g., a hazard, an overhead powerline, a tree branch, a fire escape, a vehicle in a blind spot of the refuse vehicle 10 driving alongside the refuse vehicle 10, etc.) transparent and generate a graphical representation the detected object relative to the refuse vehicle 10 such that the operator can control or monitor operation of the refuse vehicle 10 based on the graphical representation of the detected object. By way of example, the operator may drive the refuse vehicle 10 or operate the actuator assembly 440 to avoid the detected object that would otherwise be blocked from the view of the operator. By way of example, when the operator is driving the refuse vehicle 10 and turns their head to view a blind spot of the refuse vehicle 10 before changing lanes, the AR application 428 may make a B-pillar of the refuse vehicle 10 such that the operator can determine whether a vehicle is driving alongside the refuse vehicle 10.

In some embodiments, the AR application 428 displays the graphical representation and the indication 516 to the operator at the same time. Further, in some embodiments, the AR application 428 displays the graphical representation and the indication 516 to the operator at the same time that the haptic actuator of the output devices 436 (e.g., the joystick 460, the steering wheel 462, etc.) provides the haptic indication.

In some embodiments, the AR application 428 is configured to gamify driving operation and refuse collection operations. In such embodiments, performing actions correctly and efficiently earns the operator points and performing actions with mistakes loses the operator points. By way of example, while aligning the actuator assembly 440 with the refuse can, the AR application 428 may provide the indication 516 such as a guide or a target along which the arms of the actuator assembly 440 should move to engage with the refuse can. In such an example, if the operator aligns the refuse can correctly they earn points, the AR application 428 provides positive feedback (e.g., a green checkmark, a message, a congratulatory sound, etc.). Conversely, misalignment could trigger a warning and a deduction of points, displayed by the AR application 428 as a red indicator or message. By way of another example, during driving operations, if the operator follows navigational instructions (e.g., follows an arrow displayed by the AR application 428) and braking instructions (e.g., uses regenerative braking when the AR application 428 provides an indication to do so), they earn points, while if the operator does not follow the navigational instructions (e.g., navigates off course, skips a refuse can, etc.) and braking instructions (e.g., uses conventional braking instead of regenerative braking, brakes harshly, etc.), the operator may loose points. By way of other example, additional gamified elements may include completing a collection route within an optimal time, or penalties for excessive idling or fuel consumption.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A refuse vehicle, comprising:
a chassis coupled to a plurality of tractive elements;
a body assembly supported by the chassis, the body assembly defining a refuse compartment configured to receive refuse therein;
an actuator assembly configured to engage with a refuse container and to move the refuse container relative to the body assembly, at least a portion of the actuator assembly occluded from an operator's view when the operator is positioned in a cab of the refuse vehicle;
an output device providing a display; and
a control system configured to:
monitor an operation of the actuator assembly, including the portion of the actuator assembly that is occluded from the operator's view;
monitor a location of a refuse container, at least a portion of the refuse container occluded from the operator's view when the operator is positioned in the cab;
generate a graphical representation of at least one of (i) the actuator assembly during operation that includes the portion of the actuator assembly that is occluded from the operator's view or (ii) the refuse container that includes the portion of the refuse container that is occluded from the operator's view; and
overlay, by the output device, the graphical representation of at least one of the actuator assembly or the refuse container onto the display.

2. The refuse vehicle of claim 1, further comprising the cab, the cab supported by the chassis forward of the body assembly, the output device is disposed on one of a mirror that is coupled to the cab, a support pillar of the cab, or a roof of the cab.

3. The refuse vehicle of claim 1, wherein the control system is configured to generate the graphical representation of the actuator assembly and overlay, by the output device, the graphical representation of the actuator assembly onto the display.

4. The refuse vehicle of claim 1, wherein the control system is configured to overlay, by the output device, an indication of the operation of the actuator assembly onto the display, generate the graphical representation of the actuator assembly, and overlay, by the output device, the graphical representation of the actuator assembly onto the display.

5. The refuse vehicle of claim 1, wherein the graphical representation of at least one of the actuator assembly or the refuse container is overlayed onto a live video feed displayed by the display.

6. The refuse vehicle of claim 1, further comprising side mirrors including the output device, wherein the graphical representation of at least one of the actuator assembly or the refuse container is provided via the side mirrors.

7. The refuse vehicle of claim 1, wherein the output device includes an augmented reality (AR) wearable device including the display, wherein the graphical representation of at least one of the actuator assembly or the refuse container is provided via the AR wearable device.

8. The refuse vehicle of claim 7, wherein the AR wearable device is an AR headset wearable by the operator, wherein the AR headset overlays the graphical representation of at least one of the actuator assembly or the refuse container onto a field of view of the operator.

9. The refuse vehicle of claim 1, wherein a component of the refuse vehicle occludes at least a portion of the actuator assembly or the refuse container from the operator, and wherein the graphical representation includes the occluded portion of the actuator assembly or the refuse container.

10. The refuse vehicle of claim 9, wherein the component of the refuse vehicle occluding at least the portion of the actuator assembly or the refuse container from the operator includes at least one of a roof of the refuse vehicle, a panel of the refuse vehicle, or a pillar of the refuse vehicle, such that the graphical representation including the occluded portion of the actuator assembly or the refuse container overlays at least one of the roof, the panel, or the pillar.

11. The refuse vehicle of claim 10, wherein the display is positioned along at least one of the roof, the panel, or the pillar.

12. The refuse vehicle of claim 10, wherein the graphical representation includes a partially transparent representation of at least one of the roof, the panel, or the pillar.

13. The refuse vehicle of claim 1, the graphical representation is a first graphical representation of the actuator assembly, and wherein the control system is configured to:
identify an object as the refuse container;
generate a second graphical representation of the object; and
overlay, by the output device, the second graphical representation of the object onto the display.

14. The refuse vehicle of claim 1, wherein the control system is configured to provide a first indication of the actuator assembly, and wherein the control system is configured to overlay, by the output device, a second indication indicative of an alignment of the actuator assembly with the refuse container onto the display.

15. The refuse vehicle of claim 1, wherein the control system is configured to provide a first indication of the actuator assembly or the refuse container, and wherein the control system is configured to provide a second, haptic indication via a haptic actuator.

16. An augmented reality system for a refuse vehicle, comprising:
one or more processing circuits configured to:
monitor a location of an object relative to the refuse vehicle, wherein a component of the refuse vehicle occludes at least a portion of the object from an operator's view when the operator is positioned in a cab of the refuse vehicle;
generate a graphical representation of the object, including the occluded portion of the object, the graphical representation indicative of the location of the object; and
overlay the graphical representation of the object onto the component of the refuse vehicle that occludes the portion of the object.

17. The augmented reality system of claim 16, wherein the object includes an actuator assembly of the refuse vehicle, a hazard, or a refuse container.

18. The augmented reality system of claim 16, wherein the graphical representation includes a partially transparent representation of the component of the refuse vehicle.

19. The augmented reality system of claim 16, wherein the graphical representation is overlayed the component of the refuse vehicle by a first display positioned along the component of the refuse vehicle or by a second display of an augmented reality (AR) wearable device.

20. An augmented reality system for a refuse vehicle, comprising:
a display; and
one or more processing circuits configured to:
monitor a location of an actuator assembly of the refuse vehicle, wherein a component of the refuse vehicle occludes at least a portion of the actuator assembly from an operator's view when the operator is positioned in a cab of the refuse vehicle;
generate a graphical representation of the actuator assembly that includes the portion of the actuator assembly that is occluded from the operator's view, the graphical representation indicative of the location of the actuator assembly; and
overlay, on the display, the graphical representation of the actuator assembly onto a live video feed of the component of the refuse vehicle displayed by the display.
